(19) United States
(12) Patent Application Publication
(10) Pub. No.: US 2026/0058947 A1
(43) Pub. Date: Feb. 26, 2026

(54) SYSTEM AND METHOD FOR DETERMINING THE UPDATE OF A REFERENCE CREDENTIAL

(71) Applicant: VERIDAS DIGITAL AUTHENTICATION SOLUTIONS, S.L., TAJONAR (ES)

(72) Inventors: Carlos ARANA REMÍREZ, TAJONAR (ES); Javier RUIZ ARANGUREN, TAJONAR (ES); Iñigo OLCOZ BASARTE, TAJONAR (ES); Iban RODRÍGUEZ BARBARIN, TAJONAR (ES); Eduardo AZANZA LADRÓN, TAJONAR (ES)

(21) Appl. No.: 19/100,288

(22) PCT Filed: Sep. 12, 2022
(86) PCT No.: PCT/EP2022/075313

§ 371 Date: Jan. 31, 2025

(30) Foreign Application Priority Data
Aug. 3, 2022 (EP) 22382752.8

(51) Int. Cl. H04L 9/40

(52) U.S. Cl. CPC H04L 63/0861

(57) ABSTRACT

A method, system, and terminal for determining the update of a reference credential being used for authenticating a subject, the reference credential having associated a reference credential biometric mathematical representation comprising a biometric feature of the subject, wherein analysis are performed over historic identification scores or historic credential biometric mathematical representation, in order to determine the update of the reference credential of a user.

The present application claims the benefit of European application EP22382752.8 filed Aug. 3, 2022.

### BACKGROUND

For credential authentication of a person to access, for example, a place or authorized persons only area, a wide range of methods are used in the state of the art: passwords, image recognition, voice recognition, etc. . . . However, involuntary time-varying elements which may change rapidly, such as the external appearance of the user (especially when the user is very young or very old) or the pitch of the user's voice (for example, a young adult which enters his/her teenage years), can affect the recognition of the user.

For example, recognition systems may rely on an initial reference credential embedded in a multimedia file, such as, for example, an image or photograph of the user, or an audio clip of the user's voice. Thus, the authentication process may be seriously affected because of the fast variation of the biometric features of the user in relatively short periods of time. A drift between the biometric features extracted from the reference credential and the current biometric features of a user may lead to an unusual number of authentication attempts, for example, when the user's appearance or tone of voice has changed greatly due to the passage of time, or operations or alterations to their features have occurred. Furthermore, poor conditions at the time of authentication (poor lighting, high background noise), or other factors external to the user (wearing a piece of clothing that obstructs the view of their face such as sunglasses, the user no facing properly a camera, etc.) may also complicate the authentication process.

Therefore, there is a need for a system which keeps track of such variations, and trends in the authentications, in order to keep updated a useful reference for each user. Furthermore, due to a large number of apps and systems which ask users to agree with terms and/or to actively perform updates, automatic or manual updates performed by the user also have to be avoided due to user inconvenience and lack of effectiveness in terms of response of the user.

### SUMMARY

In a first aspect, a method of determining the update of a reference credential is provided. More precisely, in the method, the reference credential has associated a reference credential biometric mathematical representation comprising a biometric feature of the subject, the method comprising:
Obtaining at least one multimedia file of the subject;
Generating a first credential biometric mathematical representation comprising a biometric feature of the subject, from the received multimedia file;
Generating an identification score between the values of the generated first credential biometric mathematical representation and the reference credential biometric mathematical representation;
Verifying if the generated identification score is higher than a predetermined identification threshold;
   If the identification score is higher than the predetermined identification threshold:
      Accessing a repository of authentication records comprising a plurality of historic identification scores corresponding to a previous authentications of the subject;
      Retrieving a plurality of historic identification scores corresponding to the subject, from the repository of authentication records;
      Performing a mathematical analysis based on the generated identification score and the plurality of historic identification scores retrieved from the repository of authentication records;
      Based on the performed mathematical analysis, determining if an update condition is fulfilled,
         in case the update condition is fulfilled, triggering an update process of the reference credential biometric mathematical representation.

In a system wherein an authentication of a plurality of subjects is required, a reference credential biometric mathematical representation representing a biometric feature of each subject may be used each time an authentication is performed, thus relying on the accuracy of the reference used for each subject to authenticate with a degree of trustworthiness. However, the subject's features may change over time, and thus the reference may be outdated, thus generating false authentications, or more difficult authentications by the system. For example, the physical appearance, voice, or other physical features of the subject may change in a way that it may affect the authentication.

Therefore, by performing the above-described method, it is possible to determine an update of a reference credential biometric mathematical representation of a subject in a way that has a low interference or low impact on the user's experience. Furthermore, by performing the method, the triggering of the update may be performed before the subject has changed too much and the system is not able to authenticate him or her anymore.

In an example, the term “biometric mathematical representation” representing a biometric feature of the subject may correspond to a digitally recorded representation of a person's biometric feature, that may be used for authentication purposes because it is as individual as, for example, a fingerprint.

Examples of “biometric mathematical representations” may be what is known as biometric vectors or embeddings, or any other mathematical representation suitable for representing biometric purposes in the form of digital data. In an example, the reference credential biometric mathematical representation and the generated first mathematical representation representing a biometric feature of the subject may be embedded in data vectors. This way, data may be analyzed in a more efficient way.

According to a specific example, the reference credential biometric mathematical representation may be obtained from a reference image of the subject (for example, a digital photo of the subject). Alternatively, said mathematical representation may also be obtained from an audio sample or audio file of, for example, the voice of the subject.

Therefore, a reference credential biometric mathematical representation may be a credential used as reference to authenticate a user, embedded in any of the above-mentioned examples of biometric mathematical representations. The reference credential may be based, for example, on a reference credential file such as a photograph of the face of the user, an audio file with a voice sample of the user, a fingerprint scan of the user, a matrix with a 3D map or depth map of the face of the user, or any other file representing a biometric feature of the user, which can be obtained from the user in any way. More precisely, the file used to obtain the reference credential may be obtained when the user is granted access to a place. For example, when a user signs up for a gym, the gym staff may obtain a photograph from the user in a multimedia file, which may be used to obtain a reference credential biometric mathematical representation, thus being the reference which the system may use to authenticate the user each time he/she wants to access the gym. Another example may be when a corporate visitor signs up remotely to be able to request visits to a specific company site or facility: in such case a selfie picture can be provided by the visitor as reference credential to be used as a successful identity proof of the visitor when accessing the site or facility.

The method according to this aspect of the invention may be performed within a system comprising a terminal connected to the cloud. Thus, as previously mentioned, the terminal may be located at the entry of a place, to be used by the subject to be authenticated in order to access said place. Then, the terminal may be used to perform some or all the steps of the method. In case only part of the steps of the method are being performed locally by the terminal, the rest of the steps may be performed by the cloud.

Alternatively, all the steps of the method may also be performed within a cloud and/or by a remote server. In this case, the obtaining of the multimedia file may comprise receiving the multimedia file from a terminal, and then performing the rest of the steps of the method within one or more servers of the cloud, or a remote server. In this case, the terminal may have a capturing device to capture the file and send it to the cloud. This way, the computational load of any mathematical analysis which may be performed would be on the server.

More specifically, the method comprises obtaining at least one multimedia file from the subject. The obtaining of the multimedia file of the subject may comprise capturing a file of the subject or, alternatively, receiving the file of the subject from a remote terminal. In the case wherein the file is captured, the terminal may capture the file by using a capturing device (for example, if the multimedia file is a photograph of the user, the terminal may comprise a camera which may capture a photograph of the user), meaning the method may be executed partially (or totally) locally, i.e., within the terminal. Alternatively, the multimedia file may be captured by a terminal and sent to a cloud, and therefore, the method may be performed partially (or solely) within the cloud itself.

After obtaining the multimedia file, a first credential biometric mathematical representation is generated, comprising a biometric feature of the subject, from the received multimedia file. This way, the information of the multimedia file is embedded in a mathematical representation, which may be a lighter file than the multimedia file. For example, the photograph file may be a file of hundreds of MB, but the mathematical representation generated from said photograph file may fit in file of few hundreds of KB.

Afterwards, an identification score may be generated, between the values of the generated first mathematical representation and the reference credential biometric mathematical representation, which may fit in a file of a few hundreds of bytes or a few kilobytes. This way, a very quick and precise comparison between the two mathematical representation may be performed, resulting in an identification score which relates the likelihood of the generated first mathematical representation (which corresponds to a current authentication of the user), with the stored reference. The identification score may be comprised, for example, between 0 and 1, 0 being no likelihood at all between both representations, and 1 being a 100% of likelihood between both representations.

Furthermore, a verification of if the identification score is higher than an identification threshold is performed. This way, the user may be identified by being recognized among a plurality of reference credentials corresponding to different users which can be authenticated.

Then, if the identification score is higher than the identification threshold, a repository of authentication records is accessed, the repository comprising a plurality of historic identification scores corresponding to previous authentications of the subject. More precisely, the repository may be, for example, a database comprising a plurality of historic identification scores which are the result of the user performing authentications in the past (i.e., before the current authentication).

Afterwards, the retrieved historic identification scores are used to perform a mathematical analysis, in order to determine if an update of the multimedia file used to obtain the reference credential may be performed.

More precisely, a mathematical analysis may be performed to further determine triggering (or not) an update process of the reference credential biometric mathematical representation. The mathematical analysis may use samples in order to obtain one or more analysis parameters. More precisely, the samples used may be one or more among the plurality of historic identification scores retrieved from the repository of authentication records, and/or the current generated identification score.

The resulting analysis parameters of the mathematical analysis may be compared to an update condition which, if fulfilled, may trigger an update process of the reference credential biometric mathematical representation.

Furthermore, the following examples of mathematical analysis are explained in terms of “samples”, which refer to each input used therein, whether it may be a currently generated sample, or one or more historic sample (retrieved from the repository of authentication records). Also, each sample may have, for example, an associated timestamp, which marks the point in time when that sample was obtained (whether it was, for example, received or calculated). That is, for example, two samples from among the plurality of historic identification scores may have different timestamps: a first sample may have a previous timestamp than a second one, thus meaning that the first historic sample was calculated prior to the second historic sample. More precisely, in this example, both the first historic sample and the second historic sample may correspond to an authentication of the same user, the first authentication being performed previous to the second authentication.

A first example of a calculated analysis parameter may be a moving average. The mathematical analysis may comprise calculating a moving average over a subset of samples, which may be a predetermined number of samples obtained prior to the current authentication (with associated timestamps previous to the timestamp of the current generated sample), or samples over a window of time prior to the current authentication.

In statistics, a moving average is a calculation used to analyze a groups of samples of data by creating a series of averages of different subsets of a full data set. It may comprise calculating a plurality of averages derived from successive segments (typically of constant size and overlapping) of the values of a series of samples. Furthermore, it may be used herein as an analysis parameter which helps smooth out the influence of isolated samples with poor quality.

Some samples might be of poor quality (i.e., may not be representative of the real biometric feature of the subject) and some of good quality (i.e., may represent more accurately the biometric feature of the subject). More precisely, in the example of a multimedia file being used to generate a specific sample such as a biometric mathematical representation representing a biometric feature of the subject, the multimedia file may be a photograph of the subject. Furthermore, the photograph may suffer from a poor lighting, the subject's face may not be facing the camera properly, or an external object or part of the subject (hand, hair, etc.) may be blocking the subject's face, or other similar issues. Thus, this may result in a sample of poor quality, which may not be relevant or significant for determining the update of the reference credential in the context of a subset of samples with good quality (the poor-quality sample may represent a circumstantial state of the biometric features and may not be representative among the overall quality of the samples of a subset).

However, by performing this analysis, i.e., by calculating a moving average, the impact of random fluctuations on the quality of the samples over a specific subset of samples is mitigated.

When the moving average is calculated, it may be compared with a predetermined threshold. Thus, the moving average should remain above a certain predetermined threshold to ensure correct operation. In case the moving average is below the predetermined threshold, this may indicate that the reference credential may be becoming obsolete and therefore should be updated. Specific causes may be that the user has aged and as a consequence his/her biometric features have changed significantly since the moment the reference credential was first obtained. Furthermore, the user may have changed her appearance significantly, for example because of an accident/wound/scar, or because of plastic surgery. Therefore, the above-mentioned changes which may produce a low moving average may be enough to trigger an update of the reference credential.

A second example of an analysis parameter may be selecting a sample with a maximum value, over a period of interest. More precisely, in this case, the selected sample may be a historic identification score with a maximum value may be selected, over a subset of samples with associated timestamps previous to the timestamp of the sample corresponding to the current authentication (for example, the last X number of samples previous to the currently generated sample). Alternatively, the selection may be performed over a subset of samples with associated timestamps which are within a specific period of time, previous to the timestamp associated with the currently generated sample.

In this case, some samples might still be of poor quality, but if the reference credential is still valid, a high enough number of samples may lead to samples with a high value. More specifically, low scores may be obtained due to low quality samples. However, it is very unlikely that none of the identification scores correspond to a good quality sample. Therefore, checking if at least one of the samples exceeds a certain threshold, is a way of discriminating between a scenario with low quality samples (very variable identification scores, with probably a large range of values) and a scenario with indicating an obsolete reference credential (i.e., a scenario wherein all the identification scores will suffer a low quality and none of them will exceed a high threshold).

A third example of an analysis parameter may be a combination of the first example (moving average) or second example (selecting of the maximum sample), with the standard deviation of the specific subset of samples used to calculate said parameters. More specifically, the update condition would be fulfilled if a calculated moving average or a selected maximum value of a sample are below a corresponding predetermined threshold, and if a calculated standard deviation of the samples used to calculate the previous parameter (either the moving average or the selected maximum value) is below another predetermined threshold.

By combining the two conditions, it is more likely that the samples within the subset of samples used to calculate either parameter (moving average or selected maximum value) are representative enough, in order to perform the triggering of the update of the reference credential.

A fourth example may be performing any of the previous three examples, adding a previous filtering of the samples within the subset of samples used to calculate the parameters. The filtering may be performed by selecting samples which have a timestamp corresponding to, for example, a specific time of the day (for example, daylight). This way, it may be possible to avoid specific environmental conditions that may distort the multimedia file used to obtain the samples. For example, in case of the multimedia file being a photograph of the subject, it may be useful to avoid particularly difficult lighting conditions (e.g., direct sunlight at certain times, less light at nighttime, etc. . . . ), which may distort the sample and its trend among all the existing samples.

A fifth example of an analysis parameter may be a ratio between two subsets of samples. More precisely, two periods of interest may be defined (by selecting two subsets of samples), of the same length (a predetermined number of samples or the same period of time in length defined by their associated timestamps), the timestamp of the first subset starting immediately after the generation of the current sample, and the second subset corresponding to the immediate past. Once both subsets of samples are defined, an average is performed over each subset, or, alternatively, the sample with the maximum value among each period is selected, and their ratio is subsequently calculated.

Calculating a ratio may be defined as calculating the quantitative relation between two amounts or group of amounts (i.e., samples) showing the number of times one value contains or is contained within the other. After being calculated, the resulting ratio may be compared with a predetermined threshold.

In an embodiment, two subsets of samples may be used, wherein a first subset comprises samples obtained immediately after the generation of a reference credential, and a second subset comprises samples obtained immediately before the currently generated sample. This way we can compare the values obtained shortly after the reference credential generation (the user's biometric feature should be very similar to the one from the reference credential) and the latest samples.

A high ratio between the averages from these subsets is very likely to indicate that a user's biometric feature or features have evolved significantly, and the reference credential should be updated.

On the other hand, a low ratio may mean that the subject's biometric features have remained stable. With the verification of the present example, we can avoid unnecessary updates, for example by interpreting that low scores are due to very difficult lighting conditions/ambient noise that are characteristic of the specific terminal where authentications are being performed, but not due to the user's features evolution.

Therefore, the triggering condition may be that the average identification score in the most recent subset is below a certain threshold and the ratio between the averages for the old and new subsets is above a certain threshold (that is, average for the older subset is significantly larger than the average for the most recent subset).

Furthermore, in another example, any of the above-mentioned thresholds used to determine the verifications performed after the mathematical analysis may be determined by, for example, the threshold being configured depending on the terminal, which is being used, or the user using the terminal (for example based on age or user role). Also, the thresholds may be fixed for a group or all the terminals which can be used by the user.

Once the update of the reference credential has been triggered by any of the previous update conditions being fulfilled, the reference credential may be marked as update-pending.

Therefore, in the specific example wherein the reference credential biometric mathematical representation has been obtained from a reference image of the subject, the triggering of the update process of the reference credential biometric mathematical representation may further comprise requesting an update of the reference image of the subject.

Alternatively, if the reference credential biometric mathematical representation has been obtained from a reference audio file of the subject (for example, a sample of his voice, saying a specific word or phrase), the triggering of the update process of the reference credential biometric mathematical representation may further comprise requesting an update of the reference audio file of the subject. Furthermore, it may also comprise using the latest sample received to update the reference biometric credential, thus avoiding any impact on the user experience, and effectively keeping the reference credential up to date at no cost for the end user.

This way, either while the user is using a terminal wherein the current authentication has been performed, or afterwards (for example, in the next authentication attempt by the user), an update message may be sent to the user, to perform said update. Also, the terminal may even use the latest sample to update the reference credential.

Alternatively, the update message may be sent to the user by email, SMS, or any other type of communication to his smartphone, or any other device the user may use. The update may be performed in a terminal on the next authentication attempt of the user, or even may be performed using a portable device of the user, such a smartphone (taking a selfie, or recording a voice note, for example).

According to a further example, a pre-processing of the samples may also be performed before performing the method of determining the update of a reference credential. More precisely, the preprocessing of the samples may comprise one or more preprocesses of, for example:
Removing outliers from the historic samples: the historic identification scores clearly outside the general trend among all the retrieved historic identification scores may be discarded. This means that, in case that, for example, the multimedia file used to obtain the biometric mathematical representation corresponding to said historic identification scores is an image of the user's face, it may be the case that the image of the user may comprise sporadic problems with facial expression, external lighting, cleanliness of the camera, presence of a face mask, etc. Therefore, this problems may be detected, for example, when performing the authentication prior to the calculation of said historic identification score and may be marked as a “discardable” identification score, even though it may have been useful to identify the user at the time (maybe in a poor way, or the identification score being extremely close to the identification threshold).
Reducing variability among the historic samples: filtering out identification scores corresponding to authentications of subjects which were made under circumstances which were not optimal. For example, it may be useful to discard scores whose original files were obtained with the subject being outside a normal working distance range of the terminal. That is, the working distance which is considered optimal to achieve successful identifications. For example, in the case of images, photographs taken with the subject too far away may have too low resolution, and photographs taken with the subject too close to the camera may be distorted by, for example, optical effects.
Selecting subsets of identification scores: when retrieving historic identification scores, subsets may be selected by time of the day and/or by biometric terminal (where the multimedia file was obtained to generate the identification score), to ensure that identification scores may only be compared within subsets with equivalent conditions (for example, in the case of the multimedia file being a photograph, all the photographs may have a similar lighting condition).

According to another aspect, a terminal for determining the update of a reference credential is presented, wherein the reference credential is used for authenticating a subject, and the terminal comprises:
A capturing device for capturing at least one multimedia file from the subject;
A communications module to connect to a repository of authentication records comprising a plurality of historic identification scores corresponding to a previous authentication of the subject;
A controller configured to determine the update of a reference credential, wherein the controller is capable of:
   generating a first mathematical representation representing a biometric feature of the subject, from the received multimedia file;
   generating an identification score between the values of the generated first mathematical representation and a reference credential biometric mathematical representation representing a biometric feature of the subject;
   verifying if the generated identification score is higher than an identification threshold, and if the identification score is higher than the identification threshold:
      Accessing the repository of authentication records, and retrieve a plurality of historic identification scores corresponding to the subject, from the repository of authentication records;
      Performing a mathematical analysis based on the generated identification score and the historic identification scores retrieved from the repository of authentication records;
      Based on the performed mathematical analysis, determining if an update condition is fulfilled, and in case the update condition is fulfilled, triggering an update process of the reference credential biometric mathematical representation.

The terminal may be able to perform part or all the method to determine the update of a reference credential, as previously described. In this case, the terminal may comprise, for example, a capturing device such as a digital photo camera, or an audio recording device, in order to capture the corresponding multimedia file.

Furthermore, the terminal may be able to connect to a repository of authentication records (either located physically within the terminal, or being a remote repository such as, for example, a database found within a cloud), in order to retrieve the corresponding historic identification scores.

According to an example, the terminal may also be able to connect to a cloud, in order to send data so the cloud may perform one or more of the steps of the previously described method, the cloud being able to send back the result of the steps performed therein back to the terminal. For example, the mathematical analysis previously described in the method description, may be performed within the cloud, thus using a more efficient computational load of one or more servers within the cloud, and sending back the results to the terminal, in order to, for example, tag a specific reference credential biometric mathematical representation as “to be updated”.

According to another aspect of the invention, a further alternative method of determining the update of a reference credential is presented, wherein the reference credential is used for authenticating a subject, the method being performed using a reference credential biometric mathematical representation representing a biometric feature of the subject, wherein the method comprises the steps of:
Obtaining at least one multimedia file of the subject;
Generating a first credential biometric mathematical representation representing a biometric feature of the subject, from the received multimedia file;
Generating an identification score between the values of the generated first credential biometric mathematical representation and the reference credential biometric mathematical representation;
Verifying if the generated identification score is higher than an identification threshold;
If the identification score is higher than the identification threshold:
   Accessing a repository of authentication records comprising a plurality of historic credential biometric mathematical representations representing a biometric feature of the subject, used to generate a historic identification score, corresponding to a previous authentication of the subject;
   Retrieving a plurality of historic credential biometric mathematical representations corresponding to the subject, from the repository of authentication records;
   Performing a mathematical analysis based on the generated identification score and the plurality of historic mathematical representations retrieved from the repository of authentication records;
   Based on the performed mathematical analysis, determining if an update condition is fulfilled, and in case the update condition is fulfilled, triggering an update process of the reference credential biometric mathematical representation.

The present method may be used as an alternative to the previously described one, with the difference that the repository of authentication records from which a retrieval of data is performed comprises a plurality of historic credential biometric mathematical representations representing a biometric feature of the subject, used to generate a historic identification score. More specifically, past authentications may have been performed by obtaining a multimedia file, generating a credential biometric mathematical representation representing a biometric feature of the subject, from the received multimedia file, and generating an identification score, in order to perform the authentication by comparing the generated score with a threshold. Therefore, once an authentication is performed, the identification score used to perform the authentication may be stored for future reference within the repository (as in the method according to the first aspect of the invention), or the generated mathematical representation may be stored within the repository (i.e., the mathematical representation used to generate the score which ended up in a positive authentication, as in the above method according to a further aspect of the invention). Furthermore, both the score and the mathematical representation may be stored within repository as well.

However, even though the first part of both methods may be the same in both cases (i.e., the steps up to the accessing of the repository), when historic mathematical representations are stored and used in the mathematical analysis of the method, such analysis may be different to the ones performed using only current and/or historic scores.

According to an example, the reference credential biometric mathematical representation and the generated first credential biometric mathematical representation representing a biometric feature of the subject are embedded in data vectors.

Furthermore, in an example, the reference credential biometric mathematical representation may be obtained from a reference image of the subject, and the step of triggering the update process of the reference credential biometric mathematical representation may further comprise requesting an update of the reference image of the subject. Alternatively, the reference credential biometric mathematical representation may be obtained from a reference audio file of the subject, and the step of triggering the update process of the reference credential biometric mathematical representation may further comprise requesting an update of the reference audio file of the subject.

In an example, the repository of authentication records further may comprise, for each historic credential biometric mathematical representation, an associated timestamp related to the time when the historic identification score corresponding to the historic credential biometric mathematical representation was calculated.

In the present aspect of the invention, a mathematical analysis may be performed to further determine triggering (or not) an update process of the reference credential biometric mathematical representation. The mathematical analysis may use samples in order to obtain one or more analysis parameters. More precisely, the samples used in this example may be one or more among the plurality of historic biometric mathematical representations retrieved from the repository of authentication records, and/or the current generated biometric mathematical representation representing a biometric feature of the subject.

According to a first example, the mathematical analysis may further comprise:
Calculating the hypersphere comprising the retrieved plurality of historic credential biometric mathematical representations;
   and wherein the triggering of the update process of the reference credential biometric mathematical representation is performed only when a verification of the calculated hypersphere having a size higher than a predetermined hypersphere historic credential biometric mathematical representation threshold is positive.

According to another example, the mathematical analysis may further comprise:
Calculating the distance (for example, Euclidian distance or Manhattan distance) between each of the retrieved plurality of historic credential biometric mathematical representations;
Selecting the maximum distance from among the calculated distances;
   and wherein the triggering of the update process of the reference credential biometric mathematical representation is performed only when a maximum verification of the selected maximum distance being higher than a predetermined maximum distance threshold is positive.

In a further example, the mathematical analysis may further comprise:
Selecting at least two subsets of historic credential biometric mathematical representations among the retrieved plurality of historic credential biometric mathematical representations, and calculating a moving average based on each selected sub-set;
Calculating the distances between each calculated moving average;
Selecting the maximum distance among the calculated distances;
   and the triggering of the update process of the reference credential biometric mathematical representation may be performed only when a moving average distance verification of the selected maximum distance is higher than a predetermined moving average distance threshold.

As in the previously described method according to the first aspect of the present invention, the alternative method according to this aspect of the invention may also be performed within a system comprising a terminal connected to the cloud. Thus, as previously mentioned, the terminal may also be located at the entry of a place, to be used by the subject to be authenticated in order to access said place. Then, the terminal may be used to perform some or all the steps of the method. In case only part of the steps of the method are being performed locally by the terminal, the rest of the steps may be performed by the cloud.

Furthermore, as in the previously described method to the present one, all the steps of the method may also be performed within a cloud. In an analogous way, the obtaining of the multimedia file may comprise receiving the multimedia file from a terminal, and then performing the rest of the steps of the method within one or more servers of the cloud.

According to another aspect of the invention, a terminal for determining the update of a reference credential is presented, wherein the reference credential is used for authenticating a subject, the terminal comprising:
A capturing device for obtaining at least one multimedia file from the subject;
A communications module to connect to a repository of authentication records comprising a plurality of historic credential biometric mathematical representations, used to generate a historic identification score, corresponding to a previous authentication of the subject;
A controller configured to determine the update of a reference credential, wherein the controller is capable of:
   generate a first credential biometric mathematical representation representing a biometric feature of the subject, from the received multimedia file; and/or
   generate an identification score between the values of the generated first credential biometric mathematical representation and a reference credential biometric mathematical representation representing a biometric feature of the subject; and/or
   verify if the generated identification score is higher than an identification threshold, and if the identification score is higher than the identification threshold:
      Access the repository of authentication records, and retrieve a plurality of historic credential biometric mathematical representations corresponding to the subject, from the repository of authentication records;
      Perform a mathematical analysis based on the generated identification score and the historic credential biometric mathematical representations retrieved from the repository of authentication records; and/or
      Based on the performed mathematical analysis, determine if an update condition is fulfilled, and in case the update condition is fulfilled, trigger an update process of the reference credential biometric mathematical representation.

As previously described, the method may be performed partially or totally within such a terminal. Alternatively, a system may be presented wherein all the method is performed remotely, as previously described in this case and the previous case.

According to another embodiment, in a similar example to the above mentioned, the authentication of the user may be completed within the terminal, but the mathematical analysis may be performed using the cloud or a remote server. The advantage of such configuration may be that the authentication, which is what may be performed in real time, can be done locally using the terminal (which is usually a faster way of performing it, robust to network problems and possible even when the terminal is offline), and the following steps may be done using the cloud, wherein more relevant historic data may be used (historical records potentially obtained through other terminals). Such steps may be performed after a period of time, and do not have to be done immediately after the authentication is performed, thus being a very flexible option for such a system.

### BRIEF DESCRIPTION OF THE DRAWINGS

Non-limiting examples of the present disclosure will be described in the following, with reference to the appended drawings, in which:

FIG. 1A depicts an example of a system for determining the update of a reference credential, according to the present disclosure.

FIG. 1B depicts an example of a flow-chart of the method for determining the update of a reference credential, performed using the system of FIG. 1A, according to the present disclosure.

FIG. 2A depicts another example of a system for determining the update of a reference credential, according to the present disclosure.

FIG. 2B depicts another example of a flow-chart of the method for determining the update of a reference credential, performed using the system of FIG. 2A, according to the present disclosure.

### DETAILED DESCRIPTION OF EXAMPLES

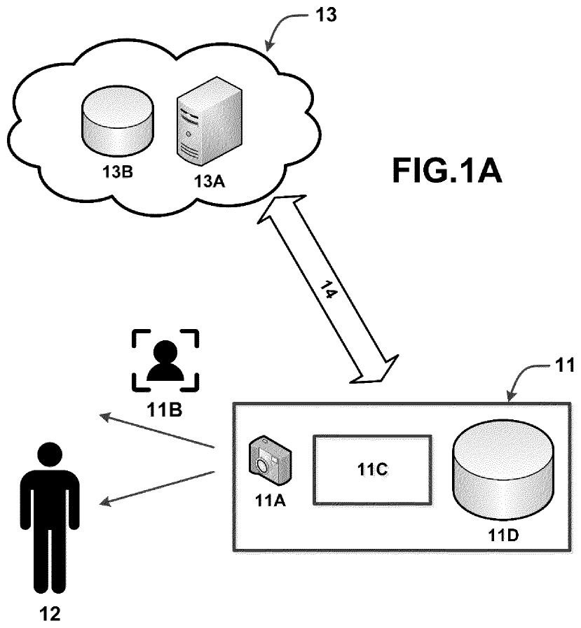

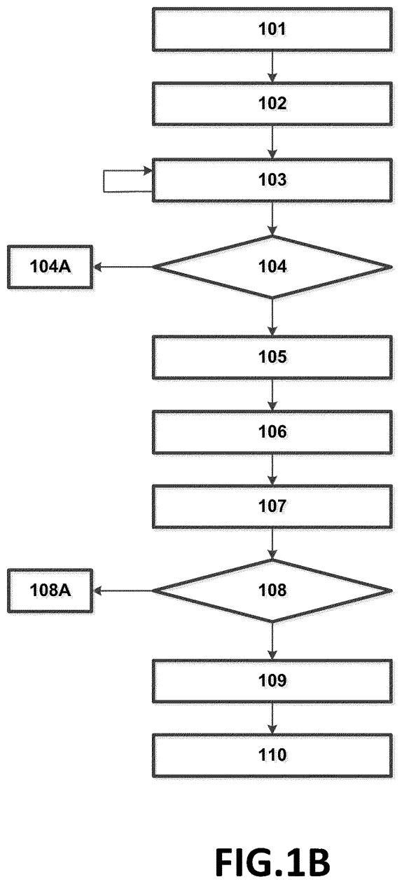

According to an example of the present disclosure, a system for determining the update of a reference credential is presented in FIG. 1A, the system comprising a terminal 11, connected through a data connection (i.e., a Wi-Fi connection 14) to a cloud computing system 13.

The terminal 11 comprises a digital camera 11A configured to acquire photographs 11B from a user 12 which may want to access, in this example, a football stadium, in order to watch a football match. The terminal 11 may be installed in one of the several access gates of the football stadium, and it may be used to authenticate club audience members of the football team, in order to provide or deny access to the seating area of the stadium. The users trying to access the stadium may be able to do so through one or more gates of the stadium, and each of the gates may have a different terminal installed to control the access therein. This way, each terminal may be able to provide access to a group of users (i.e., club members of the football team), which may be the same, different or may have an overlap of users to each terminal, depending on, for example, the type of membership each user has, or the fix seat or seats in the stadium the user is assigned to.

In this example, terminal 11 further comprises a computing device embedded in a controller 11C used to calculate a plurality of identification scores and statistic data based on an obtained photograph 11B, and further used to exchange data with cloud 13. Terminal 11 also comprises a repository of authentication records, which in this example is a terminal local database 11D, which comprises a plurality of reference credentials corresponding to the users which are allowed to access the stadium through the specific gate where the terminal 11 is installed, and a plurality of historic identification scores corresponding to authentications of users previously performed by the terminal 11. Furthermore, cloud computing system 13 comprises a computing server 13A and a cloud database 13B. The plurality of terminals used within the stadium are all connected to cloud 13, and cloud database 13B comprises, for each terminal, the same data corresponding to the plurality of historic identification scores corresponding to authentications of users previously performed by each terminal 11.

FIG. 1B depicts an example of the method of determining the update of a reference credential according to the present disclosure, the method being performed using the system of FIG. 1A.

More precisely, in step 101, terminal 11 may obtain a photograph file 11B of user 12, captured using the digital camera 11A installed therein.

In step 102, controller 11C is used to generate a first mathematical representation representing a biometric feature of the subject, from the received photograph file 11B.

In this example, the mathematical representation of the biometric feature of the subject is embedded in a biometric data vector.

Afterwards, in step 103, controller 11C is further used to generate an identification score between the values of the generated biometric data vector and each of the reference credential biometric data vectors stored within the terminal local database 11D of the terminal. Once all the identification scores are calculated, the score with the maximum value is selected, and a step 104 is performed, wherein controller 11C is used to further verify if the selected identification score (the maximum identification score among all the calculated identification scores in step 103) is higher than an identification threshold. If the selected identification score is higher than said threshold, the user is correctly identified, and the method proceeds to step 105. If the selected identification score is lower than said threshold, no authentication is performed, and the user attempting to enter the stadium is not granted access.

This way, by finding the highest identification score performed among all the reference credential biometric data vectors and verifying if it is higher than the identification threshold, the system can authenticate a user (in this example, a club member of the stadium which is allowed to access the stadium through the door where the terminal is installed) in order to provide access through the stadium gate.

In case such verification is successful, the user is authenticated, and thus a further authorization of access is performed in the next step, wherein user may be granted access through the gate where the terminal is installed. In case such verification is not successful, the user is denied access through the gate in step 104A.

Afterwards, if the authentication is successful, the terminal will proceed to the next step 105 wherein the authorization is performed (a verification is performed of if this person has the right to access through this access point at this point in time) while, at the same time, the terminal local database 11D is updated by storing the calculated identification score used to authenticate the user in the present authentication. Furthermore, the same calculated identification score is sent through the Wi-Fi connection 14 to the cloud 13, wherein cloud database 13B is also updated, therefore comprising the same historic identification scores corresponding to the terminal 11, and also stored in the terminal local database 11D found within the terminal.

However, a further determination is performed in the following steps of if the reference credential used to authenticate the user is strong enough to keep using it or, on the contrary, it needs to be updated.

More precisely, when the identification score is higher than the identification threshold, a step 106 is performed of accessing and retrieving a plurality of historic identification scores corresponding to the authenticated user 12, from terminal local database 11D.

Afterwards, in step 107, a mathematical analysis is performed using the controller 11C within the terminal 11, based on the generated identification score and the historic identification scores retrieved from terminal local database 11D.

More precisely, in the present example, the retrieved historic identification scores correspond to previous authentications performed over the previous month from the present authentication. Once they are retrieved, by identifying them through their timestamp (that is, timestamps between now and a month prior), a moving average is calculated using the retrieved data.

Once the moving average is calculated, as a result of the performed mathematical analysis, step 108 is performed of determining if an update condition is fulfilled. In this example, the update condition is the moving average being higher than a predetermined moving average threshold.

Therefore, in case the update condition is not fulfilled, the update process is discarded (i.e., there is no need to update the reference credential) in step 108A. However, if the update condition is fulfilled, the update process of the reference credential is performed in step 109, wherein the reference credential corresponding to the user is tagged as “to be updated” within the terminal local database 11D, and, in parallel, a request to flag the reference credential of the user is also sent to the cloud 13. This way, in step 110, the server 13A receives a request to update the tagged reference credential, which can be resent to any terminal connected to the cloud. This way, the next time the same user tries to access a stadium gate (which may be the gate having the same terminal used to last access, or a different one), the terminal can show a message to the user warning that an update of the reference credential has to be performed. In this example, when the user tries to access again, the terminal would use the same camera 11A used to authenticate users, to capture a new photograph of the user, in order to use it as a new reference credential of the user, thus the update of the credential being fulfilled.

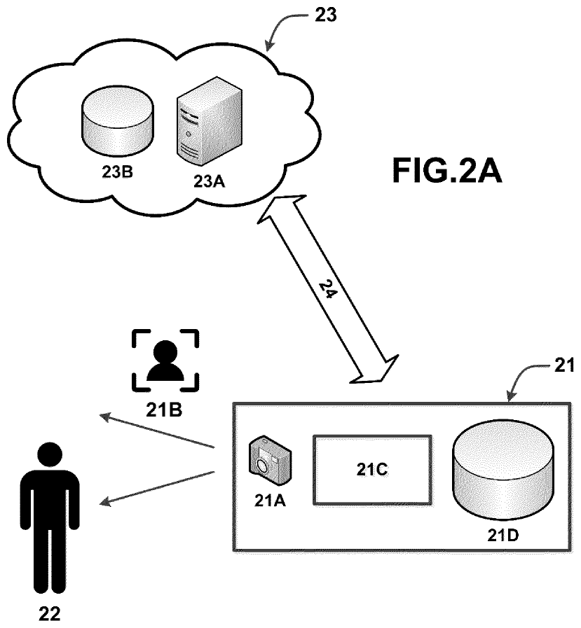

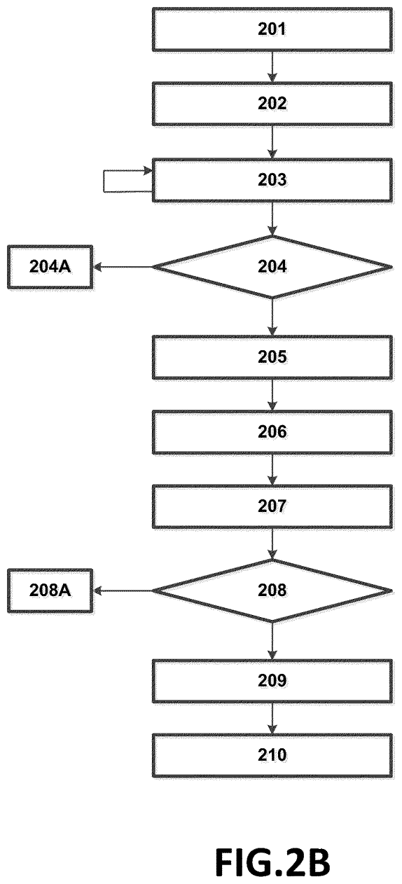

FIG. 2A depicts a second example of a system for determining the update of a reference credential, according to the present disclosure. In this example, the system comprises the same elements as in the example of FIG. 1A: a terminal 21, connected through a data connection (i.e., a Wi-Fi connection 24) to a cloud computing system 23; a digital camera 21A configured to acquire photographs 21B from a user 22, a computing device embedded in a controller 21C, and a terminal local database 21D, all within the terminal 21; and a cloud computing system 23 comprising a computing server 23A and a cloud database 23B.

However, in this example, the controller 21C is configured to receive a photograph 21B of the user 22 captured by camera 21A and send the photograph file to computing server 23A. Therefore, in this case, the mathematical analysis is performed within server 23A, and an update tag may be sent back to terminal 21, in order to fulfill the update of the reference, if needed.

FIG. 2B depicts an example of the method of determining the update of a reference credential according to the present disclosure, the method being performed using the system of FIG. 2A.

More precisely, in step 201, terminal 21 may obtain a photograph file 21B of user 12, captured using the digital camera 11A installed therein.

In step 202, controller 21C is used to send the photograph file 21B through WiFi connection 24 to server 23A. Upon receiving the file, server 23A generates a first mathematical representation representing a biometric feature of the subject, from the received photograph file 11B. In this example, the mathematical representation of the biometric feature of the subject is embedded in a biometric data vector.

Afterwards, in step 203, server 23A is further used to generate an identification score between the values of the generated biometric data vector and each of the reference credential biometric data vectors stored within the cloud's database 23D. Once all the identification scores are calculated, the score with the maximum value is selected, and a step 204 is performed, wherein server 23A is used to further verify if the selected identification score (the maximum identification score among all the calculated identification scores in step 203) is higher than an identification threshold. If the selected identification score is higher than said threshold, the user is correctly identified, and the method proceeds to step 205. If the selected identification score is lower than said threshold, no authentication is performed, and the user attempting to enter the stadium is denied of the access to it (the server 23A sends a signal to terminal 21 requesting to deny access to user 22).

This way, by finding the highest identification score performed among all the reference credential biometric data vectors and verifying if it is higher than the identification threshold, the system is able to authenticate a user (in this example, a club member of the stadium which is allowed to access the stadium through the door where the terminal is installed) in order to provide access through the stadium gate. In this example, the cloud is used to centralize the controlling of several terminals, and to make all the steps of the method. This way, the terminal can be simpler and cheaper.

In case such verification is successful, the user is authenticated, and thus access can be provided through the gate where the terminal is installed. In case such verification is not successful, access is not granted (or cannot be granted) through the gate in step 204A.

Afterwards, step 205 is performed, wherein both the cloud's database 23B and terminal local database 11D are updated by storing the calculated identification score used to authenticate the user in the present authentication within each of the databases. This way, the terminal comprises the same historic identification scores corresponding to users which have used terminal 11 to be authenticated, stored within the terminal local database 11D found within the terminal.

However, a further determination is performed in the following steps of if the reference credential used to authenticate the user is strong enough to keep using it or, on the contrary, it needs to be updated.

More precisely, when the identification score is higher than the identification threshold, a step 206 is performed of the server 23A accessing and retrieving a plurality of historic identification scores corresponding to the authenticated user 22, from cloud's database 23B.

Afterwards, in step 107, a mathematical analysis is performed by server 23A, based on the generated identification score and the historic identification scores retrieved from cloud's database 23A.

More precisely, in the present example, the retrieved historic identification scores correspond to previous authentications performed over the previous month from the present authentication. Once they are retrieved, by identifying them through their timestamp (that is, timestamps between now and a month prior), a moving average is calculated using the retrieved data.

Once the moving average is calculated, as a result of the performed mathematical analysis, step 208 is performed of determining if an update condition is fulfilled. In this example, the update condition is the moving average being higher than a predetermined moving average threshold.

Therefore, in case the update condition is not fulfilled, the update process is discarded (i.e., there is no need to update the reference credential) in step 208A. However, if the update condition is fulfilled, the update process of the reference credential is performed in step 209, wherein the reference credential corresponding to the user is tagged as “to be updated” within the cloud's database 23B, and, in parallel, a request to flag the reference credential of the user is also sent to the terminal 21.

Thus, when carrying out the analysis in the cloud/remote server, historic records may comprise identification scores obtained using some or all the terminals. Therefore, the historic records used to carry out the analysis may not be limited to those generated using the terminal carrying out the current authentication. This way, a broader range of information may be used, improving the efficiency of the analysis.

For reasons of completeness, various aspects of the present disclosure are set out in the following numbered clauses:
1. A method of determining the update of a reference credential being used for authenticating a subject, the reference credential having associated a reference credential biometric mathematical representation comprising a biometric feature of the subject, the method comprising:
   Capturing locally at least one multimedia file of the subject;
   Generating locally or in a remote computing system, a first credential biometric mathematical representation comprising a biometric feature of the subject, from the received multimedia file;
   Generating locally or in a remote computing system, an identification score between the values of the generated first credential biometric mathematical representation and the reference credential biometric mathematical representation;
   Verifying locally or in a remote computing system, if the generated identification score is higher than a predetermined identification threshold;
      If the identification score is higher than the predetermined identification threshold:
         Accessing a repository of authentication records comprising a plurality of historic identification scores corresponding to a previous authentications of the subject;
         Retrieving a plurality of historic identification scores corresponding to the subject, from the repository of authentication records;
         Performing locally or in a remote computing system, a mathematical analysis based on the generated identification score and the plurality of historic identification scores retrieved from the repository of authentication records;
         Based on the performed mathematical analysis, determining locally or in a remote computing system, if an update condition is fulfilled,
         in case the update condition is fulfilled, triggering an update process of the reference credential biometric mathematical representation.
2. Method according to clause 1, wherein the reference credential biometric mathematical representation and the generated first credential biometric mathematical representation representing a biometric feature of the subject are embedded in data vectors.
3. Method according to any of clauses 1 or 2, wherein the reference credential biometric mathematical representation is obtained from a reference image of the subject, and wherein triggering the update process of the reference credential biometric mathematical representation comprises requesting an update of the reference image of the subject.
4. Method according to any of clauses 1 or 2, wherein the reference credential biometric mathematical representation is obtained from a reference audio file of the subject, and wherein triggering the update process of the reference credential biometric mathematical representation comprises requesting an update of the reference audio file of the subject.
5. Method according to any of clauses 1 to 4, wherein the repository of authentication records further comprises, for each historic identification score, an associated timestamp related to the time when the historic identification score has been calculated.
6. Method according to clause 5, wherein only a subset of the plurality of retrieved historic identification scores is used on the mathematical analysis, based on the associated timestamp being within a predetermined time slot of the day.
7. Method according to any of clauses 1 to 6, wherein the repository of authentication records further comprises, for each historic identification score, at least one historic credential biometric mathematical representation representing a biometric feature of the subject, the historic credential biometric mathematical representation being used to obtain said historic identification score.
8. Method according to any of clauses 1 to 7, wherein the mathematical analysis comprises:
   Calculating a moving average based on the retrieved plurality of historic identification scores;
      and wherein the triggering of the update process of the reference credential biometric mathematical representation is performed only when a moving average verification of the calculated moving average being lower than a predetermined average historic identification score threshold is positive.
9. Method according to any of clauses 1 to 7, wherein the mathematical analysis comprises:
   Selecting, from among the retrieved plurality of historic identification scores, the historic identification score with a higher value;
      and wherein the triggering of the update process of the reference credential biometric mathematical representation is performed only when a maximum verification of the selected historic identification score with a higher value being lower than a predetermined maximum identification score threshold is positive.
10. Method according to any of clauses 8 or 9, wherein the mathematical analysis further comprises
   Calculating the standard deviation of the retrieved plurality of historic identification scores;
      and wherein the triggering of the update process of the reference credential data vector is performed only when the moving average verification or the maximum verification is positive, and a further standard deviation verification of the calculated standard deviation being lower than a predetermined standard deviation threshold is positive.
11. Method according to any of clauses 8 or 9, wherein two subsets of historic identification scores are selected from the retrieved plurality of historic identification scores, and wherein:
   The scores of the first subset of historic identification scores have an associated timestamp corresponding to a period of time immediately previous to the timestamp corresponding to the currently generated identification score; and
   The scores of the second subset of historic identification scores have an associated timestamp corresponding to a period of time immediately previous to the timestamp corresponding to the timestamps of the first subset;
      and wherein the method comprises:
Calculating a ratio between the calculated moving averages or the selected maximums, between the two subsets;
   and wherein the triggering of the update process of the reference credential data vector is performed only when the moving average verification or the maximum verification is positive, and a further ratio verification of the calculated ratio being higher than a predetermined ratio threshold.
12. A Terminal for determining the update of a reference credential, wherein the reference credential is used for authenticating a subject, the terminal comprising:
   A capturing device for capturing at least one multimedia file from the subject;
   A communications module to connect to a repository of authentication records comprising a plurality of historic identification scores corresponding to a previous authentication of the subject;
   A controller configured to determine the update of a reference credential, wherein the controller is capable of:
      generating a first credential biometric mathematical representation representing a biometric feature of the subject, from the received multimedia file; and/or
      generating an identification score between the values of the generated first credential biometric mathematical representation and a reference credential biometric mathematical representation representing a biometric feature of the subject; and/or
      verifying if the generated identification score is higher than an identification threshold, and if the identification score is higher than the identification threshold:
         Accessing the repository of authentication records, and retrieve a plurality of historic identification scores corresponding to the subject, from the repository of authentication records;
         Performing a mathematical analysis based on the generated identification score and the historic identification scores retrieved from the repository of authentication records; and/or
         Based on the performed mathematical analysis, determining if an update condition is fulfilled, and in case the update condition is fulfilled, triggering an update process of the reference credential biometric mathematical representation.
13. Terminal according to clause 12 wherein the capturing device is a photo camera, the multimedia file is an image of the subject, the reference credential biometric mathematical representation is obtained from a reference image of the subject, and wherein triggering the update process of the reference credential biometric mathematical representation further comprises:
   Requesting an update of the reference image of the subject.
14. Terminal according to clause 12, wherein the capturing device is an audio recording device, the multimedia file is an audio file of the subject, the reference credential biometric mathematical representation is obtained from a reference audio file of the subject, and wherein triggering the update process of the reference credential biometric mathematical representation further comprises:
   Requesting an update of the reference audio file of the subject.
15. Terminal according to any of clauses 12 to 14, wherein the repository of authentication records further comprises, for each historic identification score, an associated timestamp related to the time when the historic identification score has been calculated.
16. Terminal according to clause 15, wherein only a subset of the plurality of retrieved historic identification scores is used on the mathematical analysis, based on the associated timestamp being within a predetermined time slot of the day.
17. Terminal according to any of clauses 12 to 16, wherein the repository of authentication records further comprises, for each historic identification score, at least one historic credential biometric mathematical representation representing a biometric feature of the subject, the historic credential biometric mathematical representation being used to obtain said historic identification score.
18. Terminal according to any of clauses 12 to 17, wherein the mathematical analysis further comprises:
   Calculating a moving average based on the retrieved plurality of historic identification scores;
      and wherein the triggering of the update process of the reference credential biometric mathematical representation is performed only when a moving average verification of the calculated moving average being lower than a predetermined average historic identification score threshold is positive.
19. Terminal according to any of clauses 12 to 17, wherein the mathematical analysis further comprises:
   Selecting, from among the retrieved plurality of historic identification scores, the historic identification score with a higher value;
      and wherein the triggering of the update process of the reference credential biometric mathematical representation is performed only when a maximum verification of the selected historic identification score with a higher value being lower than a predetermined maximum identification score threshold is positive.
20. Terminal according to any of clauses 18 or 19, wherein the mathematical analysis further comprises:
   Calculating the standard deviation of the retrieved plurality of historic identification scores;
      and wherein the triggering of the update process of the reference credential data vector is performed only when the moving average verification or the maximum verification is positive, and a further standard deviation verification of the calculated standard deviation being lower than a predetermined standard deviation threshold is positive.
21. Terminal according to any of clauses 18 or 19, wherein two subsets of historic identification scores are selected from the retrieved plurality of historic identification scores, and wherein:
   The scores of the first subset of historic identification scores have an associated timestamp corresponding to a period of time immediately previous to the timestamp corresponding to the currently generated identification score; and
   The scores of the second subset of historic identification scores have an associated timestamp corresponding to a period of time immediately previous to the timestamp corresponding to the timestamps of the first subset;
      and wherein the method further comprises:
Calculating a ratio between the calculated moving averages or the selected maximums, between the two subsets;
   and wherein the triggering of the update process of the reference credential data vector is performed only when the moving average verification or the maximum verification is positive, and a further ratio verification of the calculated ratio being higher than a predetermined ratio threshold.
22. Terminal according to any of clauses 18 to 21, wherein the thresholds are determined based on the user using the terminal.
23. A method of determining the update of a reference credential, wherein the reference credential is used for authenticating a subject, the method being performed using a reference credential biometric mathematical representation representing a biometric feature of the subject, wherein the method comprises the steps of:
   Receiving from a terminal at least one multimedia file of the subject;
   Generating locally or in a remote computing system, a first credential biometric mathematical representation representing a biometric feature of the subject, from the received multimedia file;
   Generating locally or in a remote computing system, an identification score between the values of the generated first credential biometric mathematical representation and the reference credential biometric mathematical representation;
   Verifying locally or in a remote computing system, if the generated identification score is higher than an identification threshold;
   If the identification score is higher than the identification threshold:
      Accessing a repository of authentication records comprising a plurality of historic identification scores corresponding to a previous authentication of the subject;
      Retrieving a plurality of historic identification scores corresponding to the subject, from the repository of authentication records;
      Performing locally or in a remote computing system, a mathematical analysis based on the generated identification score and the plurality of historic identification scores retrieved from the repository of authentication records;
      Based on the performed mathematical analysis, determining locally or in a remote computing system, if an update condition is fulfilled, and in case the update condition is fulfilled, triggering an update process of the reference credential biometric mathematical representation.
24. Method according to clause 23, wherein the reference credential biometric mathematical representation and the generated first credential biometric mathematical representation representing a biometric feature of the subject are embedded in data vectors.
25. Method according to clauses 23 or 24, wherein the reference credential biometric mathematical representation is obtained from a reference image of the subject, and wherein triggering the update process of the reference credential biometric mathematical representation further comprises:
   Requesting an update of the reference image of the subject.
26. Method according to clause 23 or 24, wherein the reference credential biometric mathematical representation is obtained from a reference audio file of the subject, and wherein triggering the update process of the reference credential biometric mathematical representation further comprises:
   Requesting an update of the reference audio file of the subject.
27. Method according to any of clauses 23 to 26, wherein the repository of authentication records further comprises, for each historic identification score, an associated timestamp related to the time when the historic identification score has been calculated.
28. Method according to clause 27, wherein only a subset of the plurality of retrieved historic identification scores is used on the mathematical analysis, based on the associated timestamp being within a predetermined time slot of the day.
29. Method according to any of clauses 23 to 28, wherein the repository of authentication records further comprises, for each historic identification score, at least one historic credential biometric mathematical representation representing a biometric feature of the subject, the historic credential biometric mathematical representation being used to obtain said historic identification score.
30. Method according to any of clauses 23 to 29, wherein the mathematical analysis further comprises:
   Calculating a moving average based on the retrieved plurality of historic identification scores;
      and wherein the triggering of the update process of the reference credential biometric mathematical representation is performed only when a moving average verification of the calculated moving average being lower than a predetermined average historic identification score threshold is positive.
31. method according to any of clauses 23 to 29, wherein the mathematical analysis further comprises:
   Selecting, from among the retrieved plurality of historic identification scores, the historic identification score with a higher value;
      and wherein the triggering of the update process of the reference credential biometric mathematical representation is performed only when a maximum verification of the selected historic identification score with a higher value being lower than a predetermined maximum identification score threshold is positive.
32. Method according to any of clauses 30 or 31, wherein the mathematical analysis further comprises:
   Calculating the standard deviation of the retrieved plurality of historic identification scores;
      and wherein the triggering of the update process of the reference credential biometric mathematical representation is performed only when the moving average verification or the maximum verification is positive, and a further standard deviation verification of the calculated standard deviation being lower than a predetermined standard deviation threshold is positive.
33. Method according to any of clauses 30 or 31, wherein two subsets of historic identification scores are selected from the retrieved plurality of historic identification scores, and wherein:
   The scores of the first subset of historic identification scores have an associated timestamp corresponding to a period of time immediately previous to the timestamp corresponding to the currently generated identification score; and
   The scores of the second subset of historic identification scores have an associated timestamp corresponding to a period of time immediately previous to the timestamp corresponding to the timestamps of the first subset;
      and wherein the method further comprises:
Calculating a ratio between the calculated moving averages or the selected maximums, between the two subsets;
   and wherein the triggering of the update process of the reference credential biometric mathematical representation is performed only when the moving average verification or the maximum verification is positive, and a further ratio verification of the calculated ratio being higher than a predetermined ratio threshold.
34. A system for determining the update of a reference credential, wherein the reference credential is used for authenticating a subject, the system comprising:
   A communications module to connect to a repository of authentication records comprising a plurality of historic identification scores corresponding to a previous authentication of the subject;
   A controller configured to determine the update of a reference credential, wherein the controller is capable of:
      receiving from a terminal at least one multimedia file of the subject;
      generating a first credential biometric mathematical representation representing a biometric feature of the subject, from the received multimedia file; and/or
      generating an identification score between the values of the generated first credential biometric mathematical representation and a reference credential biometric mathematical representation representing a biometric feature of the subject; and/or
      verifying if the generated identification score is higher than an identification threshold, and if the identification score is higher than the identification threshold:
         Accessing the repository of authentication records, and retrieve a plurality of historic identification scores corresponding to the subject, from the repository of authentication records;
         Performing a mathematical analysis based on the generated identification score and the historic identification scores retrieved from the repository of authentication records; and/or
         Based on the performed mathematical analysis, determining if an update condition is fulfilled, and in case the update condition is fulfilled, triggering an update process of the reference credential biometric mathematical representation.
35. System according to clause 34 wherein the received multimedia file is an image of the subject, the reference credential biometric mathematical representation is obtained from a reference image of the subject, and wherein triggering the update process of the reference credential biometric mathematical representation further comprises:
   Requesting an update of the reference image of the subject.
36. System according to clause 34, wherein the received multimedia file is an audio file of the subject, the reference credential biometric mathematical representation is obtained from a reference audio file of the subject, and wherein triggering the update process of the reference credential biometric mathematical representation further comprises:
   Requesting an update of the reference audio file of the subject.
37. System according to any of clauses 34 to 36, wherein the repository of authentication records further comprises, for each historic identification score, an associated timestamp related to the time when the historic identification score has been calculated.
38. System according to clause 37, wherein only a subset of the plurality of retrieved historic identification scores is used on the mathematical analysis, based on the associated timestamp being within a predetermined time slot of the day.
39. System according to any of clauses 34 to 38, wherein the repository of authentication records further comprises, for each historic identification score, at least one historic credential biometric mathematical representation representing a biometric feature of the subject, the historic credential biometric mathematical representation being used to obtain said historic identification score.
40. System according to any of clauses 34 to 39, wherein the mathematical analysis further comprises:
   Calculating a moving average based on the retrieved plurality of historic identification scores;
      and wherein the triggering of the update process of the reference credential biometric mathematical representation is performed only when a moving average verification of the calculated moving average being lower than a predetermined average historic identification score threshold is positive.
41. System according to any of clauses 34 to 39, wherein the mathematical analysis further comprises:
   Selecting, from among the retrieved plurality of historic identification scores, the historic identification score with a higher value;
      and wherein the triggering of the update process of the reference credential biometric mathematical representation is performed only when a maximum verification of the selected historic identification score with a higher value being lower than a predetermined maximum identification score threshold is positive.
42. System according to any of clauses 40 or 41, wherein the mathematical analysis further comprises:
   Calculating the standard deviation of the retrieved plurality of historic identification scores;
      and wherein the triggering of the update process of the reference credential data vector is performed only when the moving average verification or the maximum verification is positive, and a further standard deviation verification of the calculated standard deviation being lower than a predetermined standard deviation threshold is positive.
43. System according to any of clauses 40 or 41, wherein two subsets of historic identification scores are selected from the retrieved plurality of historic identification scores, and wherein:
   The scores of the first subset of historic identification scores have an associated timestamp corresponding to a period of time immediately previous to the timestamp corresponding to the currently generated identification score; and
   The scores of the second subset of historic identification scores have an associated timestamp corresponding to a period of time immediately previous to the timestamp corresponding to the timestamps of the first subset;
      and wherein the method further comprises:
Calculating a ratio between the calculated moving averages or the selected maximums, between the two subsets;
   and wherein the triggering of the update process of the reference credential data vector is performed only when the moving average verification or the maximum verification is positive, and a further ratio verification of the calculated ratio being higher than a predetermined ratio threshold.
44. System according to any of clauses 40 to 43, wherein the thresholds are determined based on the specific terminal being used.
45. System according to any of clauses 40 to 43, wherein the thresholds are determined based on the user using the terminal.
46. A method of determining the update of a reference credential, wherein the reference credential is used for authenticating a subject, the method being performed using a reference credential biometric mathematical representation representing a biometric feature of the subject, wherein the method comprises the steps of:
   Capturing locally at least one multimedia file of the subject;
   Generating locally or in a remote computing system, a first credential biometric mathematical representation representing a biometric feature of the subject, from the received multimedia file;
   Generating locally or in a remote computing system, an identification score between the values of the generated first credential biometric mathematical representation and the reference credential biometric mathematical representation;
   Verifying locally or in a remote computing system, if the generated identification score is higher than an identification threshold;
   If the identification score is higher than the identification threshold:
      Accessing a repository of authentication records comprising a plurality of historic credential biometric mathematical representations representing a biometric feature of the subject, used to generate a historic identification score, corresponding to a previous authentication of the subject;
      Retrieving a plurality of historic credential biometric mathematical representations corresponding to the subject, from the repository of authentication records;
      Performing locally or in a remote computing system, a mathematical analysis based on the generated identification score and the plurality of historic mathematical representations retrieved from the repository of authentication records;
      Based on the performed mathematical analysis, determining locally or in a remote computing system, if an update condition is fulfilled, and in case the update condition is fulfilled, triggering an update process of the reference credential biometric mathematical representation.
47. Method according to clause 46, wherein the reference credential biometric mathematical representation and the generated first credential biometric mathematical representation representing a biometric feature of the subject are embedded in data vectors.
48. Method according to clauses 46 or 47, wherein the reference credential biometric mathematical representation is obtained from a reference image of the subject, and wherein triggering the update process of the reference credential biometric mathematical representation further comprises:
   Requesting an update of the reference image of the subject.
49. Method according to clause 46 or 47, wherein the reference credential biometric mathematical representation is obtained from a reference audio file of the subject, and wherein triggering the update process of the reference credential biometric mathematical representation further comprises:
   Requesting an update of the reference audio file of the subject.
50. Method according to any of clauses 46 to 49, wherein the repository of authentication records further comprises, for each historic credential biometric mathematical representation, an associated timestamp related to the time when the historic identification score corresponding to the historic credential biometric mathematical representation has been calculated.
51. Method according to clause 50, wherein only a subset of the plurality of retrieved historic credential biometric mathematical representations is used on the mathematical analysis, based on the associated timestamp being within a predetermined time slot of the day.
52. Method according to any of clauses 46 to 51, wherein the mathematical analysis further comprises:
   Calculating the hypersphere comprising the retrieved plurality of historic credential biometric mathematical representations;
      and wherein the triggering of the update process of the reference credential biometric mathematical representation is performed only when a verification of the calculated hypersphere having a size higher than a predetermined hypersphere historic credential biometric mathematical representation threshold is positive.
53. Method according to any of clauses 46 to 51, wherein the mathematical analysis further comprises:
   Calculating the distance between each of the retrieved plurality of historic credential biometric mathematical representations;
   Selecting the maximum distance from among the calculated distances;
      and wherein the triggering of the update process of the reference credential biometric mathematical representation is performed only when a maximum verification of the selected maximum distance being higher than a predetermined maximum distance threshold is positive.
54. Method according to any of clauses 46 to 51, wherein the mathematical analysis further comprises:
   Selecting at least two subsets of historic credential biometric mathematical representations among the retrieved plurality of historic credential biometric mathematical representations, and calculating a moving average based on each selected sub-set;
   Calculating the distances between each calculated moving average;
   Selecting the maximum distance among the calculated distances;
      and wherein the triggering of the update process of the reference credential biometric mathematical representation is performed only when a moving average distance verification of the selected maximum distance being higher than a predetermined moving average distance threshold.
55. A terminal for determining the update of a reference credential, wherein the reference credential is used for authenticating a subject, the terminal comprising:
   A capturing device for obtaining at least one multimedia file from the subject;
   A communications module to connect to a repository of authentication records comprising a plurality of historic credential biometric mathematical representations, used to generate a historic identification score, corresponding to a previous authentication of the subject;
   A controller configured to determine the update of a reference credential, wherein the controller is capable of:
      generate a first credential biometric mathematical representation representing a biometric feature of the subject, from the received multimedia file; and/or
      generate an identification score between the values of the generated first credential biometric mathematical representation and a reference credential biometric mathematical representation representing a biometric feature of the subject; and/or
      verify if the generated identification score is higher than an identification threshold, and if the identification score is higher than the identification threshold:
         Access the repository of authentication records, and retrieve a plurality of historic credential biometric mathematical representations corresponding to the subject, from the repository of authentication records;
         Perform a mathematical analysis based on the generated identification score and the historic credential biometric mathematical representations retrieved from the repository of authentication records; and/or
         Based on the performed mathematical analysis, determine if an update condition is fulfilled, and in case the update condition is fulfilled, trigger an update process of the reference credential biometric mathematical representation.
56. Terminal according to clause 55 wherein the capturing device is a photo camera, the multimedia file is an image of the subject, the reference credential biometric mathematical representation is obtained from a reference image of the subject, and wherein triggering the update process of the reference credential biometric mathematical representation further comprises:
   Requesting an update of the reference image of the subject.
57. Terminal according to clause 55, wherein the capturing device is an audio recording device, the multimedia file is an audio file of the subject, the reference credential biometric mathematical representation is obtained from a reference audio file of the subject, and wherein triggering the update process of the reference credential biometric mathematical representation further comprises:
   Requesting an update of the reference audio file of the subject.
58. Terminal according to any of clauses 55 to 57, wherein the repository of authentication records further comprises, for each historic credential biometric mathematical representation, an associated timestamp related to the time when the historic identification score corresponding to the historic credential biometric mathematical representations has been calculated.
59. Terminal according to clause 58, wherein only a subset of the plurality of retrieved historic credential biometric mathematical representations is used on the mathematical analysis, based on the associated timestamp being within a predetermined time slot of the day.
60. Terminal according to any of clauses 55 to 59, wherein the mathematical analysis further comprises:
   Calculating the hypersphere comprising the retrieved plurality of historic credential biometric mathematical representations;
      and wherein the triggering of the update process of the reference credential biometric mathematical representation is performed only when a verification of the calculated hypersphere having a size higher than a predetermined hypersphere historic credential biometric mathematical representation threshold is positive.
61. Terminal according to any of clauses 55 to 59, wherein the mathematical analysis further comprises:
   Calculating the distance between each of the retrieved plurality of historic credential biometric mathematical representations;
   Selecting the maximum distance from among the calculated distances;
      and wherein the triggering of the update process of the reference credential biometric mathematical representation is performed only when a maximum verification of the selected maximum distance being higher than a predetermined maximum distance threshold is positive.
62. Terminal according to any of clauses 55 to 59, wherein the mathematical analysis further comprises:
   Selecting at least two subsets of historic credential biometric mathematical representations among the retrieved plurality of historic credential biometric mathematical representations, and calculating a moving average based on each selected sub-set;
   Calculating the distances between each calculated moving average;
   Selecting the maximum distance among the calculated distances;
      and wherein the triggering of the update process of the reference credential biometric mathematical representation is performed only when a moving average distance verification of the selected maximum distance being higher than a predetermined moving average distance threshold.
63. Terminal according to any of clauses 60 to 62, wherein the thresholds are determined based on the user using the terminal.
64. A method of determining the update of a reference credential, wherein the reference credential is used for authenticating a subject, the method being performed using a reference credential biometric mathematical representation representing a biometric feature of the subject, wherein the method comprises the steps of:
   Receiving from a terminal at least one multimedia file of the subject;
   Generating locally or in a remote computing system, a first credential biometric mathematical representation representing a biometric feature of the subject, from the received multimedia file;
   Generating locally or in a remote computing system, an identification score between the values of the generated first credential biometric mathematical representation and the reference credential biometric mathematical representation;
   Verifying locally or in a remote computing system, if the generated identification score is higher than an identification threshold;
   If the identification score is higher than the identification threshold:
      Accessing a repository of authentication records comprising a plurality of historic credential biometric mathematical representations representing a biometric feature of the subject, used to generate a historic identification score, corresponding to a previous authentication of the subject;
      Retrieving a plurality of historic credential biometric mathematical representations corresponding to the subject, from the repository of authentication records;
      Performing locally or in a remote computing system, a mathematical analysis based on the generated identification score and the plurality of historic mathematical representations retrieved from the repository of authentication records;
      Based on the performed mathematical analysis, determining locally or in a remote computing system, if an update condition is fulfilled, and in case the update condition is fulfilled, triggering an update process of the reference credential biometric mathematical representation.
65. Method according to clause 64, wherein the reference credential biometric mathematical representation and the generated first credential biometric mathematical representation representing a biometric feature of the subject are embedded in data vectors.
66. Method according to clauses 64 or 65, wherein the reference credential biometric mathematical representation is obtained from a reference image of the subject, and wherein triggering the update process of the reference credential biometric mathematical representation further comprises:
   Requesting an update of the reference image of the subject.
67. Method according to clause 64 or 65, wherein the reference credential biometric mathematical representation is obtained from a reference audio file of the subject, and wherein triggering the update process of the reference credential biometric mathematical representation further comprises:
   Requesting an update of the reference audio file of the subject.
68. Method according to any of clauses 64 to 67, wherein the repository of authentication records further comprises, for each historic credential biometric mathematical representation, an associated timestamp related to the time when the historic identification score corresponding to the historic credential biometric mathematical representation has been calculated.
69. Method according to clause 68, wherein only a subset of the plurality of retrieved historic credential biometric mathematical representations is used on the mathematical analysis, based on the associated timestamp being within a predetermined time slot of the day.
70. Method according to any of clauses 64 to 69, wherein the mathematical analysis further comprises:
   Calculating the hypersphere comprising the retrieved plurality of historic credential biometric mathematical representations;
      and wherein the triggering of the update process of the reference credential biometric mathematical representation is performed only when a verification of the calculated hypersphere having a size higher than a predetermined hypersphere historic credential biometric mathematical representation threshold is positive.
71. Method according to any of clauses 64 to 69, wherein the mathematical analysis further comprises:
   Calculating the distance between each of the retrieved plurality of historic credential biometric mathematical representations;
   Selecting the maximum distance from among the calculated distances;
      and wherein the triggering of the update process of the reference credential biometric mathematical representation is performed only when a maximum verification of the selected maximum distance being higher than a predetermined maximum distance threshold is positive.
72. Method according to any of clauses 64 to 69, wherein the mathematical analysis further comprises:
   Selecting at least two subsets of historic credential biometric mathematical representations among the retrieved plurality of historic credential biometric mathematical representations, and calculating a moving average based on each selected sub-set;
   Calculating the distances between each calculated moving average;
   Selecting the maximum distance among the calculated distances;
      and wherein the triggering of the update process of the reference credential biometric mathematical representation is performed only when a moving average distance verification of the selected maximum distance being higher than a predetermined moving average distance threshold.
73. A system for determining the update of a reference credential, wherein the reference credential is used for authenticating a subject, the system comprising:
   A communications module to connect to a repository of authentication records comprising a plurality of historic credential biometric mathematical representations, used to generate a historic identification score, corresponding to a previous authentication of the subject;
   A controller configured to determine the update of a reference credential, wherein the controller is capable of:
      receiving from a terminal at least one multimedia file of the subject;
      generate a first credential biometric mathematical representation representing a biometric feature of the subject, from the received multimedia file; and/or
      generate an identification score between the values of the generated first credential biometric mathematical representation and a reference credential biometric mathematical representation representing a biometric feature of the subject; and/or
      verify if the generated identification score is higher than an identification threshold, and if the identification score is higher than the identification threshold:
         Access the repository of authentication records, and retrieve a plurality of historic credential biometric mathematical representations corresponding to the subject, from the repository of authentication records;
         Perform a mathematical analysis based on the generated identification score and the historic credential biometric mathematical representations retrieved from the repository of authentication records; and/or
         Based on the performed mathematical analysis, determine if an update condition is fulfilled, and in case the update condition is fulfilled, trigger an update process of the reference credential biometric mathematical representation.
74. System according to clause 73 wherein the capturing device is a photo camera, the multimedia file is an image of the subject, the reference credential biometric mathematical representation is obtained from a reference image of the subject, and wherein triggering the update process of the reference credential biometric mathematical representation further comprises:
   Requesting an update of the reference image of the subject.
75. System according to clause 73, wherein the capturing device is an audio recording device, the multimedia file is an audio file of the subject, the reference credential biometric mathematical representation is obtained from a reference audio file of the subject, and wherein triggering the update process of the reference credential biometric mathematical representation further comprises:
   Requesting an update of the reference audio file of the subject.
76. System according to any of clauses 73 to 75, wherein the repository of authentication records further comprises, for each historic credential biometric mathematical representation, an associated timestamp related to the time when the historic identification score corresponding to the historic credential biometric mathematical representations has been calculated.
77. System according to clause 76, wherein only a subset of the plurality of retrieved historic credential biometric mathematical representations is used on the mathematical analysis, based on the associated timestamp being within a predetermined time slot of the day.
78. System according to any of clauses 73 to 77, wherein the mathematical analysis further comprises:
   Calculating the hypersphere comprising the retrieved plurality of historic credential biometric mathematical representations;
      and wherein the triggering of the update process of the reference credential biometric mathematical representation is performed only when a verification of the calculated hypersphere having a size higher than a predetermined hypersphere historic credential biometric mathematical representation threshold is positive.
79. System according to any of clauses 73 to 77, wherein the mathematical analysis further comprises:
   Calculating the distance between each of the retrieved plurality of historic credential biometric mathematical representations;
   Selecting the maximum distance from among the calculated distances;
      and wherein the triggering of the update process of the reference credential biometric mathematical representation is performed only when a maximum verification of the selected maximum distance being higher than a predetermined maximum distance threshold is positive.
80. System according to any of clauses 73 to 77, wherein the mathematical analysis further comprises:
   Selecting at least two subsets of historic credential biometric mathematical representations among the retrieved plurality of historic credential biometric mathematical representations, and calculating a moving average based on each selected sub-set;
   Calculating the distances between each calculated moving average;
   Selecting the maximum distance among the calculated distances;
      and wherein the triggering of the update process of the reference credential biometric mathematical representation is performed only when a moving average distance verification of the selected maximum distance being higher than a predetermined moving average distance threshold.
81. System according to any of clauses 78 to 80, wherein the thresholds are determined based on the specific terminal being used.
82. System according to any of clauses 78 to 80, wherein the thresholds are determined based on the user using the terminal.
83. A computer program product comprising instructions to cause the device of any of claims 12 to 22 to execute the steps of the method of any of claims 1 to 11.
84. Computer program product according to claim 83, embodied on a storage medium.
85. Computer program product according to claim 83, carried on a carrier signal.
86. A computer program product comprising instructions which, when the program is executed by a computer, cause the computer to carry out the steps of the method according to any of claims 23 to 33.
87. Computer program product according to claim 86, embodied on a storage medium.
88. Computer program product according to claim 86, carried on a carrier signal.
89. A computer program product comprising instructions to cause the device of any of claims 55 to 63 to execute the steps of the method of any of claims 46 to 54.
90. Computer program product according to claim 89, embodied on a storage medium.
91. Computer program product according to claim 89, carried on a carrier signal.
92. A computer program product comprising instructions which, when the program is executed by a computer, cause the computer to carry out the steps of the method according to any of claims 64 to 72.
93. Computer program product according to claim 92, embodied on a storage medium.
94. Computer program product according to claim 92, carried on a carrier signal.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples but should be determined only by a fair reading of the claims that follow. If reference signs related to drawings are placed in parentheses in a claim, they are solely for attempting to increase the intelligibility of the claim and shall not be construed as limiting the scope of the claim.

1. A method of determining the update of a reference credential being used for authenticating a subject, the reference credential having associated a reference credential biometric mathematical representation comprising a biometric feature of the subject, the method comprising:
obtaining at least one multimedia file of the subject;
generating a first credential biometric mathematical representation comprising a biometric feature of the subject, from the received multimedia file;
generating an identification score between the values of the generated first credential biometric mathematical representation and the reference credential biometric mathematical representation; and
verifying if the generated identification score is higher than a predetermined identification threshold, wherein
if the identification score is higher than the predetermined identification threshold:
accessing a repository of authentication records comprising a plurality of historic identification scores corresponding to a previous authentications of the subject;
retrieving a plurality of historic identification scores corresponding to the subject, from the repository of authentication records;
performing a mathematical analysis based on the generated identification score and the plurality of historic identification scores retrieved from the repository of authentication records; and
based on the performed mathematical analysis, determining if an update condition is fulfilled;
wherein in case the update condition is fulfilled, triggering an update process of the reference credential biometric mathematical representation.

2. The method according to claim 1, wherein obtaining at least one multimedia file of the subject comprises capturing a file of the subject.

3. The method according to claim 1, wherein obtaining at least one multimedia file of the subject comprises receiving the file of the subject from a remote terminal.

4. The method according to claim 1, wherein the reference credential biometric mathematical representation and the generated first credential biometric mathematical representation representing a biometric feature of the subject are embedded in data vectors.

5. The method according to claim 1, wherein the reference credential biometric mathematical representation is obtained from a reference image of the subject, and wherein triggering the update process of the reference credential biometric mathematical representation comprises requesting an update of the reference image of the subject.

6. The method according to claim 1, wherein the reference credential biometric mathematical representation is obtained from a reference audio file of the subject, and wherein triggering the update process of the reference credential biometric mathematical representation comprises requesting an update of the reference audio file of the subject.

7. The method according to claim 1, wherein the repository of authentication records further comprises, for each historic identification score, an associated timestamp related to the time when the historic identification score has been calculated.

8. (canceled)

9. (canceled)

10. The method according to claim 1, wherein the mathematical analysis comprises:
calculating a moving average based on the retrieved plurality of historic identification scores;
and wherein the triggering of the update process of the reference credential biometric mathematical representation is performed only when a moving average verification of the calculated moving average being lower than a predetermined average historic identification score threshold is positive.

11. (canceled)

12. The method according to claim 10, wherein the mathematical analysis further comprises:
calculating the standard deviation of the retrieved plurality of historic identification scores;
and wherein the triggering of the update process of the reference credential data vector is performed only when the moving average verification or the maximum verification is positive, and a further standard deviation verification of the calculated standard deviation being lower than a predetermined standard deviation threshold is positive.

13. The method according to claim 10, wherein two subsets of historic identification scores are selected from the retrieved plurality of historic identification scores, and wherein:
the scores of the first subset of historic identification scores have an associated timestamp corresponding to a period of time immediately previous to the timestamp corresponding to the currently generated identification score; and
the scores of the second subset of historic identification scores have an associated timestamp corresponding to a period of time immediately previous to the timestamp corresponding to the timestamps of the first subset;
and wherein the method comprises:
calculating a ratio between the calculated moving averages or the selected maximums, between the two subsets;
and wherein the triggering of the update process of the reference credential data vector is performed only when the moving average verification or the maximum verification is positive, and a further ratio verification of the calculated ratio being higher than a predetermined ratio threshold.

14. A terminal for determining the update of a reference credential, wherein the reference credential is used for authenticating a subject, the terminal comprising:
a capturing device for capturing at least one multimedia file from the subject;
a communications module to connect to a repository of authentication records comprising a plurality of historic identification scores corresponding to a previous authentication of the subject;
a controller configured to determine the update of a reference credential, wherein the controller is capable of:
generating a first mathematical representation representing a biometric feature of the subject, from the received multimedia file;
generating an identification score between the values of the generated first mathematical representation and a reference credential biometric mathematical representation representing a biometric feature of the subject; and
verifying if the generated identification score is higher than an identification threshold, and if the identification score is higher than the identification threshold:
accessing the repository of authentication records, and retrieve a plurality of historic identification scores corresponding to the subject, from the repository of authentication records;
performing a mathematical analysis based on the generated identification score and the historic identification scores retrieved from the repository of authentication records; and
based on the performed mathematical analysis, determining if an update condition is fulfilled, and in case the update condition is fulfilled, triggering an update process of the reference credential biometric mathematical representation.

15. The terminal according to claim 14 wherein the capturing device is a photo camera, the multimedia file is an image of the subject, the reference credential biometric mathematical representation is obtained from a reference image of the subject, and wherein triggering the update process of the reference credential biometric mathematical representation further comprises:
requesting an update of the reference image of the subject.

16. The terminal according to claim 14, wherein the capturing device is an audio recording device, the multimedia file is an audio file of the subject, the reference credential biometric mathematical representation is obtained from a reference audio file of the subject, and wherein triggering the update process of the reference credential biometric mathematical representation further comprises:
requesting an update of the reference audio file of the subject.

17. (canceled)

18. (canceled)

19. (canceled)

20. The terminal according to claim 14, wherein the mathematical analysis further comprises:
calculating a moving average based on the retrieved plurality of historic identification scores;
and wherein the triggering of the update process of the reference credential biometric mathematical representation is performed only when a moving average verification of the calculated moving average being lower than a predetermined average historic identification score threshold is positive.

21. The terminal according to claim 14, wherein the mathematical analysis further comprises:
selecting, from among the retrieved plurality of historic identification scores, the historic identification score with a higher value;
and wherein the triggering of the update process of the reference credential biometric mathematical representation is performed only when a maximum verification of the selected historic identification score with a higher value being lower than a predetermined maximum identification score threshold is positive.

22. The terminal according to claim 20, wherein the mathematical analysis further comprises:
calculating the standard deviation of the retrieved plurality of historic identification scores;
and wherein the triggering of the update process of the reference credential data vector is performed only when the moving average verification or the maximum verification is positive, and a further standard deviation verification of the calculated standard deviation being lower than a predetermined standard deviation threshold is positive.

23. The terminal according to claim 20, wherein two subsets of historic identification scores are selected from the retrieved plurality of historic identification scores, and wherein:
the scores of the first subset of historic identification scores have an associated timestamp corresponding to a period of time immediately previous to the timestamp corresponding to the currently generated identification score; and
the scores of the second subset of historic identification scores have an associated timestamp corresponding to a period of time immediately previous to the timestamp corresponding to the timestamps of the first subset;
and wherein the method further comprises:
calculating a ratio between the calculated moving averages or the selected maximums, between the two subsets;
and wherein the triggering of the update process of the reference credential data vector is performed only when the moving average verification or the maximum verification is positive, and a further ratio verification of the calculated ratio being higher than a predetermined ratio threshold.

24. (canceled)

25. A non-transitory recording medium storing a computer readable control program comprising instructions which, when the program is executed by a computer, cause the computer to carry out the steps of the method according to claim 1.

26. (canceled)

27. The non-transitory recording medium according to claim 25, carried on a carrier signal.
